(19) United States
(12) Patent Application Publication
(10) Pub. No.: US 2010/0226838 A1
(43) Pub. Date: Sep. 9, 2010

(54) PROCESS FOR THE REMOVAL OF CATALYST DEGRADATION PRODUCTS

(76) Inventors: Anand Kumar Bachasingh, Amsterdam (NL); Arie Van Zon, Amsterdam (NL)

Correspondence Address: SHELL OIL COMPANY, P O BOX 2463, HOUSTON, TX, 772522463, US

(21) Appl. No.: 12/600,703

(22) PCT Filed: May 28, 2008
(86) PCT No.: PCT/EP08/56548

§ 371 Date: May 19, 2010

(30) Foreign Application Priority Data
May 30, 2007 (EP) 07109210.0

(51) Int. Cl. C22B 11/00; C22B 15/00; B01D 11/00; C22B 34/30; B01D 37/00; C22B 34/10; C22B 61/00; C22B 23/00

(52) U.S. Cl. 423/22; 423/23; 423/24; 423/42; 423/53; 423/54; 423/55; 423/56; 423/62; 423/63; 423/65; 423/67; 423/70; 423/81; 423/84; 423/138; 423/139; 423/140; 423/143

(57) ABSTRACT

The present invention relates to a process for the removal of metal catalyst degradation products from a bleed stream of a catalytic chemical reaction process, wherein the catalyst is based on a metal selected from those in group VIII of the periodic table, chromium, copper, molybdenum, tungsten, rhenium, vanadium, titanium and zirconium, said process comprising treatment of the bleed stream with an alkali metal carbonate or ammonium carbonate source to form a solid complex or an aqueous solution of said solid complex, and removal of the solid complex or the aqueous solution of said solid complex from the bleed stream.

### FIELD OF THE INVENTION

The present invention relates to a process for the removal of metal catalyst degradation products from the bleed stream of a catalytic chemical reaction process.

### BACKGROUND OF THE INVENTION

Several important industrial chemical reactions are catalysed using a catalyst based on a metal selected from group VIII of the periodic table (according to ‘previous IUPAC form’, the Periodic Table of the Elements as published in R C Weast (Ed,) “Handbook of Chemistry and Physics”, 54^{th} edition, CRC Press, inside cover), chromium, copper, molybdenum, tungsten, rhenium, vanadium, titanium or zirconium. Illustrative, but not exhaustive, examples of such industrial chemical reactions that may be catalysed using a catalyst based on one or more of these metals are hydroformylation, carbonylation, and olefin oligomerisation and polymerisation reactions.

It is known that most catalysts have a finite lifetime, typically due to poisoning of the catalyst by impurities/by-products present in, or produced during, a chemical reaction, or due to the catalyst becoming degraded by temperature or pressure. Catalyst degradation products are typically present in any industrial catalytic chemical reaction process. Catalyst degradation products often have different catalytic properties than the original catalyst. For instance, catalyst degradation products may be catalytically inactive, or in some cases, they may catalyse competing reactions, either of the original chemical reactant, or of the desired chemical product.

Catalyst degradation products may be homogeneous within the process stream or may exist as, or form, a solid.

Because catalysts are often an expensive component in continuously operated industrial chemical reactions, it is desirable to recycle at least a portion of the active catalyst. However, if the degraded catalyst does not catalyse the desired reaction, and may even catalyse undesirable side reactions, it would be desirable to remove at least some of the catalyst degradation products. Another problem that can be experienced in catalysed chemical reaction systems, is that the presence of catalyst degradation products can promote further degradation of the active catalyst.

In some catalytic chemical reaction processes, therefore, degraded catalysts, as well as other by-products may be removed from the reaction process as a ‘bleed stream’, in order to lower the levels of degradation products in a reaction system.

Such a bleed stream must then be destroyed or re-used, for example by burning. This may be carried out purely to destroy the bleed stream, or alternatively, the bleed stream may be combined with fuel, e.g. diesel, and burnt in order to provide energy. In any of these methods, the presence of catalyst degradation products in the bleed stream is undesirable, both for environmental reasons and due to the loss of valuable metals.

Furthermore, the bleed stream of any chemical reaction process will undoubtedly contain some of the desired product from the reaction process. A method of treating such a bleed stream that allows recovery of some or all of the desired reaction product would also be an advantage.

It would therefore be desirable to find a simple method for removing catalyst degradation products from catalysts comprising metals selected from group VIII of the periodic table (according to ‘previous IUPAC form’, the Periodic Table of the Elements as published in R C Weast (Ed,) “Handbook of Chemistry and Physics”, 54^{th} edition, CRC Press, inside cover), chromium, copper, molybdenum, tungsten, rhenium, vanadium, titanium or zirconium, from bleed streams. It would also be advantageous if such a process allowed recovery of any of the desired product remaining in the bleed stream. Furthermore, it would be highly desirable to obtain the metal in a form in which it could easily be re-used.

U.S. Pat. No. 4,404,119 and U.S. Pat. No. 4,400,299 are directed to related processes for re-forming di-cobalt octacarbonyl from a tetracarbonylcobaltate salt by-product, by oxidising an aqueous solution of said by-product and extracting the oxidised by-product.

U.S. Pat. No. 4,255,279 describes a process for demetalling an oxo product contaminated with cobalt containing catalyst residues, said process comprising treating the oxo product with an aqueous solution of a cobalt salt of an acid, demetalling the thus treated oxo product with acid in the presence of oxygen, subjecting the thus formed aqueous cobalt solution in a high-pressure preformer and then extracting the formed cobalt carbonyls.

U.S. Pat. No. 5,336,473 describes a stripper-reactor capable of removing volatile cobalt species from a crude product of a cobalt-catalyses hydroformylation reaction. U.S. Pat. No. 5,235,112 is directed to a method for removing cobalt using such a stripper-reactor.

U.S. Pat. No. 5,354,908 describes a method for absorbing cobalt compounds into an olefin stream using an absorber-reactor.

A further method for removing cobalt from the crude product of a hydroformylation reaction is described in U.S. Pat. No. 5,237,105. This multi-step process involves the incorporation of an acid-air cobalt-demetalling step upstream of a cobalt flash hydroformylation catalyst recovery process.

The processes described in the prior art for removing catalyst degradation processes, particularly from hydroformylation reaction output streams are all complex and expensive, and involve high temperature and pressure steps.

### SUMMARY OF THE INVENTION

The present invention relates to a process for the removal of metal catalyst degradation products from a bleed stream of a catalytic chemical reaction process, wherein the catalyst is based on a metal selected from those in group VIII of the periodic table, chromium, copper, molybdenum, tungsten, rhenium, vanadium, titanium and zirconium, said process comprising treatment of the bleed stream with an alkali metal carbonate or ammonium carbonate source to form a solid complex or an aqueous solution of said solid complex, and removal of the solid complex or the aqueous solution of said solid complex from the bleed stream.

### DETAILED DESCRIPTION OF THE INVENTION

It has surprisingly been found that metal catalyst degradation products can be removed from a bleed stream of a catalytic chemical reaction process, in a simple manner, by treatment of the catalyst degradation products with a alkali metal carbonate or ammonium carbonate source and removal of the resultant solid or an aqueous solution of said solid complex from the bleed stream.

The catalysts of the present invention may be based on any metal, selected from the group of group VIII metals, chromium, copper, molybdenum, tungsten, rhenium, vanadium, titanium and zirconium, or compounds thereof suitable for catalysing a chemical reaction, that undergoes some degradation during that reaction. The term ‘group VIII metal’, as used herein refers to metals within group VIII of the periodic table according to the ‘previous IUPAC form’ nomenclature indicated in the Periodic Table of the Elements as published in R C Weast (Ed,) “Handbook of Chemistry and Physics”, 54^{th} edition, CRC Press, inside cover. Preferably, the metal is selected from iron, cobalt and nickel. In one preferred embodiment of the present invention, the metal is cobalt.

The catalytic chemical reaction process is suitably any chemical reaction process which is catalysed by catalyst based on a metal selected from those in group VIII of the periodic table, chromium and copper. Suitable reaction processes include, but are not limited to hydroformylation, carbonylation, dimerisation, trimerisation, tetramerisation, oligomerisation or polymerisation of organic monomers, dimerisation, trimerisation, tetramerisation, oligomerisation or polymerisation of olefins, hydrovinylation, hydrocyanation, C—C bond formation, oxidation, epoxidation, redox reactions, isomerisation, aromatic substitution, olefin metathesis/disproportionation, cross-coupling, Michael addition, hydrogenation, dehydrogenation, isomerisation, dehydration, alkoxylation, alkylation, and trans-alkylation. Preferably, the chemical reaction is selected from hydroformylation, carbonylation, dimerisation, trimerisation, tetramerisation, oligomerisation or polymerisation of olefins, hydrocyanation, C—C bond formation and hydrogenation.

Examples of specific embodiments of chemical reaction processes suitable for the present invention are an olefin hydroformylation process, (i.e. the hydroformylation of at least one olefinic compound), and an olefin dimerisation, trimerisation, tetramerisation, oligomerisation or polymerisation process (i.e. a process for dimerising, trimerising, tetramerising, oligomerising or polymerising at least one olefinic monomer).

In the present invention, the catalytic chemical reaction process is carried out in a chemical reactor system, which comprises at least one chemical reaction zone and at least one separation zone. Typically, the chemical reactor system comprises: at least one inlet; at least one reaction zone; at least one separation zone; at least one chemical product outlet; a bleed stream outlet and, optionally one or more further waste stream outlet(s).

If the catalytic chemical reaction is to be performed in a continuous fashion, the chemical reactor system may also comprise a recycle loop configured so as to recycle at least a portion of the process stream back to the at least one reaction zone.

The at least one inlet of the chemical reactor system is used to feed the components of the process stream to the at least one reaction zone. Commonly, the chemical reactor system comprises more than one inlet. Typically, the chemical reactor system comprises from 1 to 10 inlets. Each inlet in the chemical reactor system may be used to introduce a single component of the process stream or several components of the process stream. In some instances, the catalyst based on a metal selected from those in group VIII of the periodic table, chromium, copper, molybdenum, tungsten, rhenium, vanadium, titanium or zirconium, is homogeneous in the reaction mixture, under the reaction conditions, and may be introduced in the form of discrete constitutional components via several inlets and the active homogeneous catalyst is then formed in-situ. The catalyst may also be heterogeneous and fixed or supported in one or more of the reaction zones.

The term “reaction zone” as used herein means a controlled environment which contains the process stream, and wherein the chemical reaction process may occur. A reaction zone can be, for example, a reactor or a section of a reactor in which the reaction conditions such as temperature and pressure, for example, may be controlled independently from the rest of the reactor. Typically, the reaction zones are reactors.

By the term “separation zone” as used herein, it is meant a zone in which a product stream is separated from the process stream. The means for separating the product stream from the process stream is not critical to the present invention. Typically, the means for separating the product stream from the process stream includes a means selected from: decantation; evaporation; distillation; flashing; two-phase separation; filtration; membrane separation; settling; falling-film separation; wiped-film separation; and centrifugation. Preferably, the means for separating the product stream from the process stream comprises at least one means selected from: decantation; distillation; flashing; two-phase separation; falling-film separation; wiped-film separation; or settling.

The chemical product outlet provides a means to collect the product stream which is separated from the process stream in the at least one separation zone.

The optional recycle loop is used to recycle at least a portion of the process stream which has had the product stream separated from it back to the at least one reaction zone, said portion of the process stream typically comprising at least one organic compound, active homogeneous catalyst and catalyst degradation products.

At any stage during the reaction, separation or recycle steps, a portion of material comprising catalyst degradation product is removed from the reaction process via the bleed stream outlet. This portion of material comprising catalyst degradation products is termed herein a ‘bleed stream’. As well as the catalyst degradation products, the bleed stream may also contain organic compounds such as inert gaseous organic compounds, dissolved inert gaseous organic compounds, reactant compounds, product compounds, co-catalyst compounds, promoters, stabilisers, secondary catalysts, solvents and by-products of the chemical reaction process, and also inorganic compounds such as inert gaseous inorganic compounds, dissolved inert gaseous inorganic compounds, inorganic reactant compounds, inorganic product compounds, inorganic catalyst compounds, co-catalyst compounds, promoters, stabilisers, secondary catalysts, inorganic solvents (e.g. water) and inorganic by-products of the chemical reaction process.

In order to be successfully subjected to the process of the present invention, the bleed stream must contain a metal selected from those in group VIII of the periodic table, chromium, copper, molybdenum, tungsten, rhenium, vanadium, titanium and zirconium, which metal exists in at least one oxidation state within the bleed stream such that it will react with an alkali metal carbonate or ammonium carbonate source to form a solid complex of the metal. More specifically the bleed stream may contain metal ions in a +2 or +3 oxidation state. Such ions may be present in the bleed stream on its removal from the reaction process or may be formed after this point.

The metal ions in a +2 or +3 oxidation state may be formed after removal of the bleed stream from the reaction process by the specific addition of chemicals in order to effect the required oxidation and/or reduction required to form such ions, or by aging of the bleed stream. As used herein ‘aging’ refers to the storage of the bleed stream under conditions which will form the required metal ions in a +2 or +3 oxidation state from the metallic compounds present in the bleed stream when it is removed from the reaction process. Such conditions may include exposure to air and/or other gasses.

Aging typically takes place over a period of time of at least one day, preferably at least 2 days, more preferably at least 5 days. The length of time over which aging can occur does not have a particular upper limit providing that the required metal ions in a +2 or +3 oxidation state are present when the stream is subjected to the process of the present invention. Suitably, the aging takes place over a period of no more than 5 years, preferably no more than 2 years, more preferably no more than 1 year, even more preferably no more than 6 months.

The alkali metal carbonate source can be any suitable chemical compound comprising both an alkali metal and group which will form carbonate ions (CO₃²⁻) in the conditions under which the bleed stream is treated with the alkali metal carbonate source. Alkali metal as used herein refers to metals in group IA of the periodic table (according to ‘previous IUPAC form’, the Periodic Table of the Elements as published in R C Weast (Ed,) “Handbook of Chemistry and Physics”, 54^{th} edition, CRC Press, inside cover). The alkali metal may, therefore, be selected from one or more of lithium, sodium, potassium, rubidium, cesium or francium. Preferably, the alkali metal is selected from lithium, sodium, potassium or mixtures thereof.

The ammonium carbonate source comprises an ammonium (NH₄⁺) ion and a group which will form carbonate ions in the conditions under which the bleed stream is treated with the ammonium carbonate source.

The group which will form carbonate ions in the conditions under which the bleed stream is treated with the alkali metal carbonate or ammonium carbonate source is preferably selected from a carbonate (CO₃²⁻) anion or a bicarbonate (HCO₃⁻) anion.

Treatment of the bleed stream with the alkali metal carbonate or ammonium carbonate source may be carried out under any conditions that will enable the formation of a solid complex or an aqueous solution of said solid complex in the catalyst degradation product.

Treatment of the bleed stream with an alkali metal carbonate or ammonium carbonate source, as described herein, encompasses addition of the alkali metal carbonate or ammonium carbonate source as a discrete compound or reagent, and also addition of reactants that will form the required alkali metal carbonate or ammonium carbonate source under the prevailing conditions. Preferably, treatment of the bleed stream with an alkali metal carbonate or ammonium carbonate source, as described herein, involves addition of the alkali metal carbonate or ammonium carbonate source as a discrete compound or reagent.

The alkali metal carbonate or ammonium carbonate source may be added neat or as a solution in any suitable solvent. In one embodiment of the present invention the alkali metal carbonate or ammonium carbonate source is added to the bleed stream as an aqueous solution. In another embodiment of the present invention, an aqueous solvent and the alkali metal carbonate or ammonium carbonate source are added separately to the bleed stream in order to form an aqueous solution.

Whether added neat or in solution, the alkali metal carbonate or ammonium carbonate source may be added to the bleed stream, comprising metal ions in a +2 or +3 oxidation state, portionwise, slowly over an extended period of time, e.g. 30 minutes, 1 hour, 2 hours, 4 hours, 8 hours or 1 day, or in a single portion.

Once added, the alkali metal carbonate or ammonium carbonate source must be mixed with the bleed stream comprising metal ions in a +2 or +3 oxidation state. This can be carried out by any means known to the person skilled in the art including, but not being limited to, stirring, shaking or agitating.

The treatment may occur at any suitable temperature. Preferably, the treatment occurs at a temperature of at least 0, more preferably at least 10° C. Suitably, the treatment occurs at a temperature of at most 100, preferably at most 80, more preferably at most 60, more preferably at most 50, even more preferably less than 50, most preferably at most 40° C. In one preferred embodiment of the present invention, the treatment is carried out at ambient temperature, that is, without any external heating or cooling source. It will be readily apparent to the person skilled in the art that a process carried out at ambient temperature, that is, without any external heating or cooling source, would be advantageous in light of the reduced cost involved in providing the heating and/or cooling and the specialist equipment required for such a process.

The treatment may also occur at any suitable pressure. Preferably the treatment occurs at a pressure of less than 500 kPa, more preferably less than 400 kPa, even more preferably less than 250 kPa. Preferably the treatment occurs at a pressure of at least 50 kPa. In one preferred embodiment of the present invention, the treatment is carried out at ambient pressure, that is, without any external pressure or vacuum source. It will be readily apparent to the person skilled in the art that a process carried out at ambient pressure would be advantageous in light of the reduced cost involved in the energy required for providing a specific pressure level and the specialist equipment required for such a process.

The process of the present invention may be carried out in any suitable environment. However, it is an advantage of the present invention that no specific environment is required for it to be carried out successfully. In a preferred embodiment of the present invention, the process may be carried out in air.

Before treatment with the alkali metal carbonate or ammonium carbonate source, the bleed stream comprising metal ions in a +2 or +3 oxidation state may contain at least 100, more preferably at least 500, most preferably at least 1000 ppmw of metal ions. Suitably, before treatment with the alkali metal carbonate or ammonium carbonate source, the bleed stream comprising metal ions in a +2 or +3 oxidation state may contain at most 10000, more preferably at most 8000, most preferably at most 5000 ppmw of metal ions.

The alkali metal carbonate or ammonium carbonate source may be added in an molar ratio of alkali metal or ammonium ion to group VIII metal, chromium, copper, molybdenum, tungsten, rhenium, vanadium, titanium or zirconium in the range of from 10:1 to 1:10, preferably in the range of from 5:1 to 1:5, more preferably in the range of from 2:1 to 1:1. Further, the alkali metal carbonate source is suitably added in an amount such that the molar ratio of carbonate anion (once formed) to group VIII metal, chromium, copper, molybdenum, tungsten, rhenium, vanadium, titanium or zirconium in the range of from 5:1 to 1:5, preferably in the range of from 2:1 to 1:2.

The solid formed by reaction of the metal source with the bleed stream comprising metal ions in a +2 or +3 oxidation state may be removed from the bleed stream by any suitable method known in the art. Examples of suitable methods include, but are not limited to, filtration, decanting, centrifugal separation techniques and addition of an aqueous solvent, followed by phase separation.

Following treatment of the bleed stream comprising metal ions in a +2 or +3 oxidation state with the alkali metal carbonate or ammonium carbonate source and separation of the solid formed, the bleed stream preferably contains less than 500 ppm metal ions, more preferably less than 350 ppm metal ions.

The separated solid product may be disposed of by usual chemical disposal routes. Alternatively, the separated solid product may be treated by a simple method in order to recover the metal species for subsequent regeneration and re-use. In one preferred embodiment of the present invention, the solid product is treated with acid in order to form a useable species.

In one particularly preferred embodiment of the present invention the catalytic chemical reaction process is a process for the hydroformylation of an olefinic compound having at least one carbon-to-carbon double bond to produce an alcohol and/or aldehyde, comprising the steps of:

(i) contacting the olefinic compound with carbon monoxide and a source of hydrogen in the presence of a homogeneous hydroformylation catalyst based on cobalt, to produce a process stream, the process stream additionally comprising a degradation product of the homogeneous catalyst;

(ii) separating a product stream comprising an alcohol and/or aldehyde from the process stream; and

(iii) removing at least a portion of the process stream as a bleed stream.

Preferably, the hydroformylation catalyst is based on nickel, rhodium or cobalt, more preferably cobalt. Examples of cobalt-based hydroformylation catalysts include unmodified cobalt catalysts, such as those used in the oxo process, and organophosphine modified cobalt hydroformylation catalysts. In one embodiment, the hydroformylation catalyst is an organophosphine modified cobalt hydroformylation catalyst.

The organophosphine modified cobalt hydroformylation catalyst comprises cobalt in complex combination with carbon monoxide and an organophosphine ligand. By the term “complex combination” as used herein, is meant a coordination compound formed by the union of one or more carbon monoxide with one or more cobalt atoms. In one embodiment, the organophosphine component present in the organophosphine modified cobalt hydroformylation catalyst is also in complex combination with one or more cobalt atoms in addition to the carbon monoxide. In its active form the suitable organophosphine modified cobalt hydroformylation catalyst contains one or more cobalt components.

Suitable organophosphine ligands include those having a trivalent phosphorus atom having one available or unshared pair of electrons. Any essentially organic derivative of trivalent phosphorus with the foregoing electronic configuration is a suitable ligand for the cobalt catalyst.

Organic radicals of any size and composition may be bonded to the phosphorus atom. For example the organophosphine ligand may comprise a trivalent phosphorus having aliphatic and/or cycloaliphatic and/or heterocyclic and/or aromatic radicals satisfying its three valencies. These radicals may contain a functional group such as carbonyl, carboxyl, nitro, amino, hydroxy, saturated and/or unsaturated carbon-to-carbon linkages, and saturated and/or unsaturated non-carbon-to-carbon linkages.

It is also suitable for an organic radical to satisfy more than one of the valencies of the phosphorus atom, thereby forming a heterocyclic compound with a trivalent phosphorus atom. For example, an alkylene radical may satisfy two phosphorus valencies with its two open valencies and thereby form a cyclic compound. Another example would be an alkylene dioxy radical that forms a cyclic compound where the two oxygen atoms link an alkylene radical to the phosphorus atom. In these two examples, the third phosphorus valency may be satisfied by any other organic radical.

Another type of structure involving trivalent phosphorus having an available pair of electrons is one containing a plurality of such phosphorus atoms linked by organic radicals. This type of a compound is typically called a bidentate ligand when two such phosphorus atoms are present, a tridentate ligand when three such phosphorus atoms are present, and so forth.

Suitable organophosphine modified cobalt hydroformylation catalysts and their methods of preparation are disclosed in U.S. Pat. No. 3,369,050, U.S. Pat. No. 3,501,515, U.S. Pat. No. 3,448,158, U.S. Pat. No. 3,448,157, U.S. Pat. No. 3,420,898 and U.S. Pat. No. 3,440,291, all of which are incorporated herein by reference.

The specific olefinic compound having at least one carbon-to-carbon double bond used in the specific hydroformylation embodiment of the present invention is not critical to the present invention. Preferably, the olefinic compound for the hydroformylation process of the present invention is a C₃ to C₄₀ olefin, more preferably a C₅ to C₃₀ olefin and most preferably a C₆ to C₂₀ olefin. The olefinic compound may be: acyclic or cyclic; mono-olefinic or poly-olefinic; an internal-olefin or alpha-olefin; substituted or unsubstituted. Preferably, the olefinic compound is an optionally substituted C₃ to C₄₀ mono-olefin.

If the olefinic compound having at least one olefinic carbon-to-carbon double bond is substituted, the substituent is typically inert under reaction conditions. Typically, the substituent is a hydrocarbyl group or based upon a heteroatom selected from O, N, Si, P or S, preferably O, N or Si. Examples of suitable hydrocarbyl substituents include cyclic or acyclic alkane, alkene and alkyne groups and aromatic rings, commonly, the hydrocarbyl substituents will be acyclic alkane groups. Examples of suitable substituents based upon a heteroatom include alcohol groups, amine groups, silane groups and the like.

The source of hydrogen in the hydroformylation process can be any hydrogen source used in the art for hydroformylation processes. Typically, the hydrogen source in the hydroformylation process is selected from acids, water, hydrogen (H₂, either gaseous hydrogen or dissolved hydrogen gas) or any combination thereof. Preferably, the source of hydrogen for the hydroformylation process is selected from water and/or gaseous hydrogen. More preferably, the source of hydrogen is gaseous hydrogen.

The process stream for the hydroformylation embodiment comprises at least the homogeneous hydroformylation catalyst, the olefinic compound, the product alcohol and/or aldehyde, carbon monoxide and hydrogen. The product stream comprises at least the product alcohol and/or aldehyde.

Admixtures of promoters and/or stabilizers and the like may also be included in the hydroformylation process of the present invention. Thus, minor amounts of phenolic stabilizers such as hydroquinone and/or alkaline agents such as hydroxides of alkali metals, for example NaOH and KOH, may be added to the reaction zone.

The olefin hydroformylation process may be performed under any known hydroformylation reaction conditions. The specific reaction conditions for the hydroformylation process are not critical and would be known to the person skilled in the art of hydroformylation.

Typically, the hydroformylation process may be performed at pressures in the range of from about 1×10⁵ Pa up to about 2×10⁸ Pa or higher. The specific pressure used is governed to some extent by the specific charge and catalyst employed. In general, pressures in the range of from about 2×10⁶ Pa to 10×10⁶ Pa and particularly in the range of from about 2.7×10⁶ Pa to about 9×10⁶ Pa are preferred.

Typically, the hydroformylation process may be performed at temperatures in the range of from about 0° C. up to about 300° C. The specific temperature used is governed to some extent by the specific charge and catalyst employed. In general, temperatures in the range of from about 80° C. to about 250° C., particularly in the range of from about 120° C. to about 240° C., are preferred.

The ratio of catalyst to the olefinic compound to be hydroformylated is generally not critical and may vary widely. It may be varied to achieve a substantially homogeneous reaction mixture. Solvents are therefore not required. However, the use of solvents which are inert, or which do not interfere to any substantial degree with the desired hydroformylation reaction under the conditions employed, may be used. Saturated liquid hydrocarbons, for example, may be used as solvent in the process, as well as alcohols, ethers, acetonitrile, sulfolane, and the like. The molar ratio of catalyst to the olefinic compound in the reaction zone at any given instant is typically at least about 1:1000000, preferably at least about 1:10000, and more preferably at least about 1:1000, and preferably at most about 10:1. A higher or lower ratio of catalyst to olefinic compound may, however, be used, but in general it is less than 1:1.

The total molar ratio of the source of hydrogen to carbon monoxide may vary widely. In general, a mole ratio of at least about 1:1, hydrogen to carbon monoxide, based upon H₂ being used as the source of hydrogen, is employed. Suitably, ratios of hydrogen to carbon monoxide, based upon H₂ being used as the source of hydrogen, comprise those within the range of from about 1:1 to about 10:1. Higher or lower ratios may, however, be employed.

The ratio of hydrogen to carbon monoxide employed is governed to some extent by the nature of the reaction product desired. If conditions are selected that will result primarily in an aldehyde product, only about one mole of hydrogen per mole of carbon monoxide (based upon H₂ being used as the source of hydrogen) reacts with the olefinic compound. When an alcohol is the preferred product of the process of the present invention, about two moles of hydrogen and about one mole of carbon monoxide (based upon H₂ being used as the source of hydrogen) react with each mole of olefinic compound.

In the case of hydroformylation, it is generally preferred to operate the process in a continuous manner and to recycle at least a portion of the process stream which has had the product stream separated from it back to the at least one reaction zone.

The bleed stream may be removed from the hydroformylation reaction process at any point, if the reaction is carried out as a continuous process. In a batch process, the bleed stream is preferably removed after completion of the hydroformylation reaction.

The bleed stream from the hydroformylation reaction process is preferably aged by exposure to air over a period of from 2 days to 6 months. The present invention will now be illustrated by the following non-limiting examples.

### EXAMPLES

In the Examples of the present invention a bleed stream was taken from a catalytic hydroformylation process. Said process involved hydroformylation of a C₆ to C₂₀ olefin stream using an organophosphine modified cobalt catalyst. The bleed stream was then aged under ambient conditions, in contact with air for 14 days.

### Example 1

An aqueous solution of 3.6 g sodium hydrogen carbonate (NaHCO3) in 51 g water was prepared. 10 g of this solution was added to 100 g of the aged hydroformylation bleed stream. Before treatment, the bleed stream contained 2100 ppmw cobalt. The mixture was vigorously stirred at ambient temperature and pressure for about two hours. The colour of the mixture changed from deep purple to transparent-yellow, and solids settled on the bottom of the bottle after stirring stopped. The solids were separated from the liquid phase by decanting and subsequently washed with toluene and pentane. The cobalt concentration in the decanted liquid phase and the solids were determined by ICP-AES (according to ASTM-7260). The cobalt content in the liquid phase was found to be 154 ppmw and the solids were found to consist of 24 wt % cobalt.

### Example 2

1 g of water and 1.2 g of sodium carbonate (Na₂CO₃) were added to 50 g of the aged hydroformylation bleed stream. Before treatment, the bleed stream contained 2100 ppmw cobalt. The mixture was vigorously stirred at ambient temperature and pressure for 90 minutes. The colour of the mixture changed from deep purple to transparent-yellow, and solids settled on the bottom of the bottle after stirring stopped. The solids were separated from the liquid phase by filtration. The cobalt concentration in the decanted liquid phase and the solids were determined by ICP-AES (according to ASTM-7260). The cobalt content in the liquid phase was found to be 120 ppmw and the solids were found to consist of 5.3 wt % cobalt.

### Example 3

4.6 g of potassium bicarbonate (KHCO₃) were added to 60 g of the aged hydroformylation bleed stream along with water in an amount such that the concentration of water in the resultant mixture was 3.7 wt %. Before treatment, the bleed stream contained 2100 ppmw cobalt. The mixture was vigorously stirred at ambient temperature and pressure for 75 minutes. The colour of the mixture changed from deep purple to transparent-yellow, and solids settled on the bottom of the bottle after stirring stopped. The solids were separated from the liquid phase by filtration. The cobalt concentration in the decanted liquid phase and the solids were determined by ICP-AES (according to ASTM-7260). The cobalt content in the liquid phase was found to be 150 ppmw and the solids were found to consist of 2.0 wt % cobalt.

### Example 4

3.3 g of potassium carbonate (K₂CO₃) were added to 50 g of the aged hydroformylation bleed stream along with water in an amount such that the concentration of water in the resultant mixture was 6.5 wt %. Before treatment, the bleed stream contained 2100 ppmw cobalt. The mixture was vigorously stirred at ambient temperature and pressure for about two hours. The colour of the mixture changed from deep purple to transparent-yellow, and solids settled on the bottom of the bottle after stirring stopped. The solids were separated from the liquid phase by filtration. The cobalt concentration in the decanted liquid phase and the solids were determined by ICP-AES (according to ASTM-7260). The cobalt content in the liquid phase was found to be 97 ppmw and the solids were found to consist of 11.4 wt % cobalt.

These results clearly demonstrate an effective method for the removal of cobalt from an aged bleed stream from a catalytic hydroformylation reaction.

1. A process for the removal of metal catalyst degradation products from a bleed stream of a catalytic chemical reaction process, wherein the catalyst is based on a metal selected from those in group VIII of the periodic table, chromium, copper, molybdenum, tungsten, rhenium, vanadium, titanium and zirconium, said process comprising treatment of the bleed stream with an alkali metal carbonate or ammonium carbonate source to form a solid complex or an aqueous solution of said solid complex, and removal of the solid complex or the aqueous solution of said solid complex from the bleed stream.

2. A process according to claim 1, wherein the catalyst degradation products comprise said metals as metal ions in a +2 or +3 oxidation state.

3. claim 2, wherein the catalyst is based on a metal selected from iron, nickel and cobalt.

4. A process according to claim 3, wherein the catalyst is based on cobalt.

5. A process according to claim 1, wherein the catalytic chemical reaction process is an olefin hydroformylation process.

6. A process according to claim 1, wherein the alkali metal of the alkali metal carbonate source is selected from potassium, sodium, lithium and mixtures thereof.

7. A process according to claim 1, wherein the alkali metal carbonate source comprises a source of carbonate ions selected from a carbonate anion and a bicarbonate anion.

8. A process according to claim 1, wherein the treatment is carried out at a temperature of at least 0° C. and less than 50° C.

9. A process according to claim 1, wherein the treatment is carried out at a pressure of at least 50 kPa and at most 400 kPa.

10. A process according to claim 1, wherein the treatment is carried out in air.

11. A process according to claim 1, wherein treatment of the bleed stream with an alkali metal carbonate or ammonium carbonate source involves addition of the alkali metal carbonate or ammonium carbonate source as a discrete compound or reagent.

12. A process according to claim 1, wherein the solid complex is removed from the bleed stream by filtration or decanting.

13. A process according to claim 1, wherein the aqueous solution of said solid complex is removed from the bleed stream by liquid-liquid separation.
